(19) United States
(12) Patent Application Publication
(10) Pub. No.: US 2015/0087223 A1
(43) Pub. Date: Mar. 26, 2015

(54) SYSTEM FOR CONTROLLING THE USAGE OF MOBILE DEVICE IN A VEHICLE

(71) Applicant: Lloyd Cadigan, Millstone Township, NJ (US)

(72) Inventor: Lloyd Cadigan, Millstone Township, NJ (US)

(21) Appl. No.: 14/038,708

(22) Filed: Sep. 26, 2013

(51) Int. Cl. H04K 3/00

(52) U.S. Cl. CPC H04K 3/415
USPC 455/1

(57) ABSTRACT

A system for controlling the usage of mobile device in a moving vehicle is disclosed in the present invention. Said system comprises of a GPS device and a cell phone blocker. When said GPS detects the vehicle is in a speed over a pre-determined threshold, said GPS activates said cell phone blocker which blocks the use of cell phones in said vehicle.

### BACKGROUND OF THE INVENTION

### Field of the Invention

The present invention relates to a mobile device controlling system. More particularly, it relates to a system for controlling the usage of a mobile device, such as a cell phone, in a vehicle.

About 90% of the American population now owns a cell phone. Use of cell phones while driving raises safety concerns. According to a recent survey, An estimated 58.8 percent of the state's licensed drivers have used a cell phone while driving and The average reported time per day spent talking on a cell phone while driving was 14.5 minutes. A varied and growing body of literature provides convincing evidence that cell phone use while driving leads to poorer driving performance and increased risk of crash involvement. Drivers who use cell phones are four times more likely to be in a crash while using a cell phone. The annual cost of crashes caused by cell phone use is estimated to be $43 billion.

The U.S. Department of Transportation has launched many programs and initiatives to reduce traffic-related death and injuries. Increasing number of States are passing laws explicitly prohibit talking, text-messaging on hand-held mobile phones while driving. Some municipals passed ordinances prohibiting all use of the cell phones while driving. Thus it is in great need to have a system that controls the use of the cell phone while driving.

The field of this invention is for a mobile device controlling system that when placed into a road vehicle it acts to turn off the ability to use a cell phone device. This invention can be used by parents looking to make sure there young drivers adhere to the rules of the road. Additionally, commercial vehicles can be equipped with said invention to make sure that employees are also adhering to the rules of the road while operating expensive trucks from one location to another. This will ensure that not only the vehicles are safely operated but that valuable cargo will be better protected. There may even be added value with insurance companies if such insurance companies are aware of said device and offer reduced rates for the installation of such an invention.

Beyond these examples, this invention lends itself for usage in the following:
1. school buses
2. government owned trucks and cars
3. heavy trucks
4. train operating compartments.

Some related prior inventions are disclosed as prior art herein. More specifically, by way of example, U.S. PreGrant Publication No. US201110275321 to Zhou et al. discloses an integrated vehicle key and mobile phone controlling system. When the vehicle key is in use, it activates the mobile phone controlling system to block the use of mobile phone in the vehicle.

U.S. PreGrant Publication No. US200410077339 to Martens discloses a cell phone blocker that is controlled by a control unit connected to gear transmission switch. When the vehicle is ignited and transmission is engaged, the cell phone blocker blocks the use of cell phone in said vehicle.

U.S. Pat. No. 7,123,874 to Brennan discloses a cellular phone blocker. The said blocker is coupled with the ignition switch or ignition system. When the blocker detects the engine is running, or activated by turning on the ignition system, the use of cellular phone is blocked.

The above referenced prior arts all have one thing in common, that is the cell phone use is blocked whenever the vehicle is turned on. But all above referenced prior arts cannot distinguish a stopped running vehicle or a moving running vehicle. Thus, in the situation that the vehicle driver needs to use his/her cell phone when the vehicle is running but stopped, he/she has to turn off the car. Examples of such situations are when the vehicle is in a parking lot or when the driver is stuck in a traffic jams, which happen very common in our modern life. Thus, it is desirable to have a cell phone controlling system that blocks the use of cell phone only when the vehicle is in motion.

### SUMMARY OF THE INVENTION

In an exemplary embodiment of the present invention, there is disclosed a system for controlling the usage of a mobile device in a moving vehicle, comprising a Global Positioning System (GPS) device, a cell phone blocker which can block the use of cell phone when activated. These two systems work in conjunction with one another to create a unique system unto itself.

The general outline of the basic concept of a GPS system is well known and well documented. Such a system consists of a receiver that calculates its position by timing signals sent by GPS satellite system that circles the earth. This satellite gives off signals as it circles the earth in regard to its location relative to the earth itself. The receiver uses these signals to determine location itself. RF or radio carrier frequency can be used to create such tracking functionality. Radio Frequency is stronger than GPS signals.

This location is then displayed usually with a moving map display within a car itself.

Herein this invention the GPS is used to detect the motion of the vehicle. When the vehicle is turned on, the GPS is turned on and it detects the speed of the vehicle as well as it's movement. When the speed of said vehicle is over a pre-determined threshold or motion itself is detected, the GPS will activate said second feature of this invention and that is a cell phone blocking device. Said blocker will block the use of a cell phone within a predefined location within in the vehicle itself.

This interplay between the GPS system and the Cell phone blocking system will allow for a car user to be prevented from cell phone access during movement of the vehicle itself. Technology is such that a blocking signal can be very fine tuned in nature. Within a car itself, zones can be created. One zone can encircle the drivers seat but not the passenger seat for example. This being said the system described herein can be tuned as such that only the driver of a vehicle will be without access to her cell phone during movement of the vehicle itself. While passengers inside a car would still have access to cell phone use, the driver herself would be blocked from access to a cell phone.

It is duly noted that instead of GPS signals this invention can also be created to work with Radio Carrier Frequency. This is a stronger system than GPS and has the added benefit of reaching through concrete and steel. While GPS is discussed herein, it should be understood that Radio Frequency can also be employed.

This system would then be able to prevent cell phone usage, text messaging, or any dangerous activity with a cellular related device during the task of driving.

The current approach is for a car user to remain on a so-called honor system to prevent improper usage of a cellular device during the driving of a car. Yet as with seat belt usage and car navigation systems, certain car imposed systems have evolved that take the task of something dangerous away from being voluntary to one of being mandatory for the proper functioning of the car itself.

The field of this invention is much broader than for usage within cars. As such this invention can be used by parents looking to make sure there young drivers adhere to the rules of the road. Additionally, commercial vehicles can be equipped with said invention to make sure that employees are also adhering to the rules of the road while operating expensive trucks from one location to another. This will ensure that not only the vehicles are safely operated but that valuable cargo will be better protected. There may even be added value with insurance companies if such insurance companies are aware of said device and offer reduced rates for the installation of such an invention.

Beyond these examples, this invention lends itself for usage in the following:
1. school buses
2. government owned trucks and cars
3. heavy trucks
4. train operating compartments.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of the system of present invention.

### DESCRIPTION OF THE PREFERRED EMBODIMENT

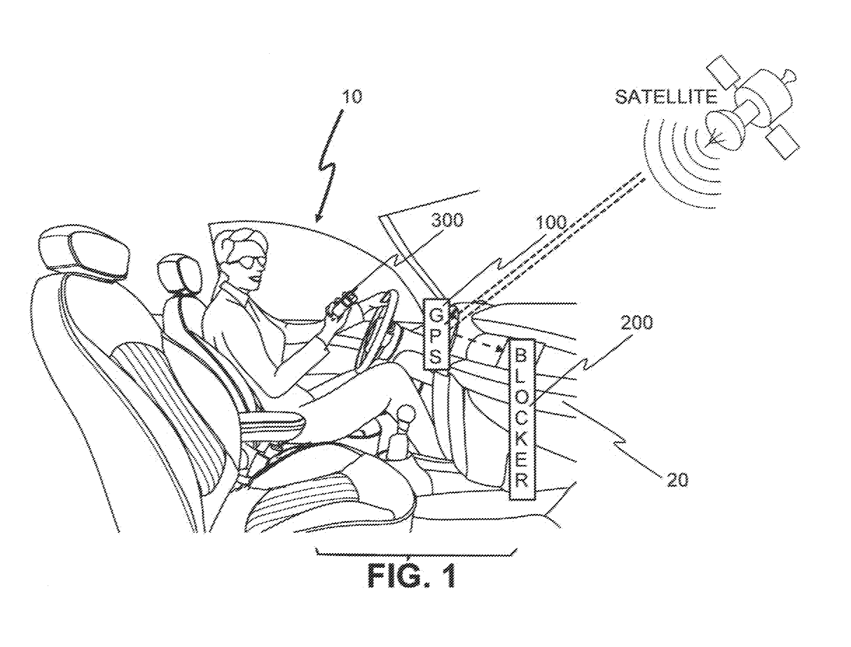

Referring to FIG. 1, there is disclosed a system 20 for controlling the usage of mobile device in a moving vehicle 10, comprising a GPS device 100, and a cell phone blocker 200, which blocks the use of cell phones 300 when activated. Said GPS 100 is mounted in the vehicle. When the vehicle 10 is turned on, said GPS 100 is turned on. The GPS 100 detects the motion of the vehicle 10. When the speed of said vehicle is detected to be over a pre-determined speed threshold, the GPS 100 will activate the cell phone blocker 200, which emits signals to block the use of a cell phone 30.

In one embodiment of the present invention, said GPS is any kind of commercially available GPS devices.

In another embodiment of the present invention, said GPS is mounted in the vehicle.

In another embodiment of the present invention, the cell phone blocker is any commercially available cell phone blocking device, also known as cell phone jammer, or forced cell phone call disruption device.

In another embodiment of the present invention, the cell phone blocker only blocks the cell phone within the vicinity of driver's seat and does not block the cell phones beyond driver's seat region.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for controlling the use of cell phones in a moving vehicle, comprising a GPS device and a cell phone blocker.

2. A system for controlling the use of cell phones in a moving vehicle of claim 1, wherein when said GPS detects said vehicle moves in a speed faster than a pre-determined threshold, said GPS activates said cell phone blocker which emits a signal that blocks said cell phone usage within said vehicle.

3. A system for controlling the use of cell phones in a moving vehicle of claim 2, wherein said GPS device is any commercially available device.

4. A system for controlling the use of cell phones in a moving vehicle of claim 2, wherein said cell phone blocker is any commercially available cell phone blocker, which is also known as cell phone jammer or forced cell phone call disruption device.

5. A system for controlling the use of cell phones in a moving vehicle of claim 2, the cell phone blocker only blocks the cell phone within the vicinity of the driver's seat and does not block the cell phones that are located outside of the zone of the driver's seat region.

6. A system for controlling the use of cell phones in a moving vehicle, comprising a Radio Carrier Frequency (RF) and a cell phone blocker or jamming devise.

7. A system for controlling the use of cell phones in a moving vehicle of claim 6, wherein when in said Radio Carrier Frequency (RF) detects said vehicle moves in a speed faster than a pre-determined threshold, said Radio Carrier Frequency (RF) activates said cell phone blocker or jammer which emits a signal that blocks said cell phone usage within said vehicle.
